(19) United States
(12) Patent Application Publication
(10) Pub. No.: US 2008/0307711 A1
(43) Pub. Date: Dec. 18, 2008

(54) Vehicle Door with a Variable Latching Function

(75) Inventors: Simon Kern, Darmstadt (DE); Juergen Maas, Kelkheim (DE); Bernd Seiler, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: Daimlerchrysler AG, Stuttgart (DE)

(21) Appl. No.: 11/793,538

(22) PCT Filed: Dec. 7, 2005
(86) PCT No.: PCT/EP05/13094

§ 371 Date: Jan. 23, 2008

(30) Foreign Application Priority Data
Dec. 22, 2004 (DE) 10 2004 061 686.8

(51) Int. Cl. B60J 5/04

(52) U.S. Cl. 49/501

(57) ABSTRACT

A vehicle door with a variable latching function which holds the vehicle door in a desired latched position by applying a latching torque using a controllable damper is described. An evaluation and control unit detects the desired latched positions by evaluating an instantaneous door movement sensed by a sensor system and actuates the damper using an actuator element. The evaluation and control unit releases the latched position after a corresponding activation is detected. The variable latching function acts on the vehicle door within a functional region which extends to a predefined opening region between a first opening angle and a maximum opening angle when the vehicle door drops below a predefined speed or comes to a standstill within the functional region.

### CROSS REFERENCE TO RELATED APPLICATIONS

This application is a National Phase of PCT International Application No. PCT/EP2005/013094, filed Dec. 7, 2005, which claims priority under 35 U.S.C. § 119 to German Patent Application No. 10 2004 061 686.8 filed Dec. 22, 2004, the entire disclosures of which are herein expressly incorporated by reference.

### BACKGROUND AND SUMMARY OF THE INVENTION

The invention relates to a vehicle door with a variable latching function holding the door in a desired latched position by applying a torque with a controllable damper.

If vehicle doors are opened carelessly, it is easy for collisions with obstacles to occur, resulting in damage to the door or to the obstacle. A frequently occurring scenario is people getting out of the vehicle in tight parking spaces or garages. In this context, it is often necessary to open the door as far as possible against the neighboring vehicle or the wall for it to be possible at all to get out of the vehicle. This requires a latching mechanism with variable latching which allows the door to be positioned precisely. With current latching mechanisms, which generally have only one or two permanently predefined latching positions for the door, this is not possible. The door often opens too wide or does not remain opened.

German Patent Document DE 42 24 132 A1 describes a door securing system, in particular for a motor vehicle door or a flap, in which the door is held in any desired intermediate position within the opening area. The door securing system includes a piston cylinder unit which, by using connecting elements, is connected on one side to the element to be moved and on the other side to the base element. The piston cylinder unit has a pressure pipe in which a working space which is filled with a damping medium is divided in two by a piston on a piston rod, wherein the piston rod is guided radially by a piston rod guide. A valve which is arranged inside a flow connection and locks the volume region between the working spaces is actuated in such a way that when a door movement impulse is applied at any desired point on the door the locking valve opens and remains opened irrespective of the pressure within the door securing system until the locking valve is closed again when a braking impulse is applied to the door.

German Patent Document DE 197 54 167 A1 discloses a device for infinitely variable locking of a component which can pivot about an axis, in particular of doors and flaps. The described device includes at least one cylinder and a piston with an electrorheological or magnetorheological liquid, an electronic control system through which the electrical or magnetic field strength in the rheological liquid can be adjusted, and a device for sensing or inputting of a desired locking position. The electronic control system can be actuated as a function of the sensed or input locking position. If an obstacle is sensed in the planned pivoting region by a camera during the opening process, an electronic evaluation system activates the electronic control system in such a way that the door is locked before the obstacle is reached.

One object of exemplary embodiments of the invention is to provide a vehicle door with a variable latching function which reliably detects and holds a desired latched position.

This and other objects and advantages are achieved by the vehicle door according to the invention, in which a variable latching function holds the vehicle door in a desired latched position by applying a latching torque, using a controllable damper. The variable latching function acts on the vehicle door within a functional region which extends to a predefined opening region between a first opening angle and a maximum opening angle if the vehicle door drops below a predefined speed, or comes to a standstill, within the functional region. Since it is not possible to get in or out of the vehicle when a vehicle door is opened to a small extent, the functional region of the variable latching function does not extend over the entire opening region of the vehicle door. That is, in a first segment of the opening region of the vehicle door up to, for example, an opening angle of 15° the vehicle door does not latch when a stationary state is detected.

In one advantageous embodiment, the vehicle door according to the invention moves into an initial position which is represented by a minimum opening angle when the vehicle door is positioned within the first segment of the opening region which extends between the minimum opening angle and the first opening angle. As a result, the vehicle door advantageously drops automatically into the lock without any further external influence if the vehicle door is positioned within the first segment of the opening region. This functionality is advantageously made possible by limiting the region of action of the variable latching function.

In a further embodiment of the vehicle door according to the invention, a latching torque for holding the desired latched position is configured in such a way that it can be applied or released in a timed fashion. This advantageously prevents jolting and the latching in is configured in a haptically pleasant way for a user.

The latching torque can be applied or released, for example, by using at least one PT₂ element with a predefined time constant.

In a further refinement of the vehicle door according to the invention, the latching torque for holding the vehicle door in the latched position which corresponds to a region about a central latched position can be set as a function of an identified, current deviation from the central latched position. As a result, the energy requirement of the controllable damper for generating the holding torque can be advantageously reduced.

In a further embodiment of the vehicle door according to the invention, an evaluation and control unit detects the desired latched position if the user lets go of an internal or external door handle or a door frame during or after a detected movement of the vehicle door.

The activation for releasing the latched position is detected by the evaluation and control unit if, for example, the user grasps the internal or external door handle or the door frame.

In a further embodiment of the vehicle door according to the invention a corresponding sensor system monitors the internal or external door handle or the door frame for activation by the user. The operating comfort for activating or deactivating the variable latching function is thus increased.

In an additional or alternative embodiment of the vehicle door according to the invention, the evaluation and control unit detects the activation for releasing the latched position if a force-proportional deflection of the vehicle door about the central latched position is detected, wherein the applied force at least overcomes rigidities which are inherent to the system in the vehicle door or in the damper or in the attachments. Since low force applications are compensated by the system-inherent rigidities, any detected deflection about the latched position can be assigned to an activation force in a uniquely defined way, as a result of which the desire of the user to switch off the latching function can be advantageously detected.

The evaluation and control unit releases the latched position if, for example, the deflection of the vehicle door out of the latched position reaches or exceeds a predefined threshold value.

Alternatively or additionally, a pressure sensor or force sensor detects the applied force and the evaluation and control unit releases the latched position if the detected force reaches or exceeds a predefined threshold value.

The electronic variable latching function according to the invention allows the vehicle door to be held in any desired position in which it is positioned within the functional region. After a maximum latching force has been overcome, the door is released again. In an alternative embodiment of the electronic variable latching function with comfort activation, the latching force is switched off and the door can be moved virtually without force if the door is grasped on the external handle or internal handle or on the door frame in which activation sensors are integrated. By evaluating the activation sensors the evaluation and control unit detects the activation request of the user and activates or deactivates the variable latching function in accordance with the detected activation request.

Various exemplary embodiments which result from the combined subject matter described in the claims an the specification are also included as belonging to the invention.

Other objects, advantages and novel features of the present invention will become apparent from the following detailed description of the invention when considered in conjunction with the accompanying drawings.

### BRIEF DESCRIPTION OF THE DRAWINGS

Advantageous embodiments of the invention are illustrated in the drawings and will be described below.

In the drawings:

FIG. 1 is a schematic block diagram of the components of a vehicle door with a latching function according to exemplary embodiments of the invention;

FIG. 2 is a detailed block diagram of the vehicle door with a latching function from FIG. 1;

FIG. 3 is a schematic illustration of a movement range of the vehicle door from FIG. 1;

FIG. 4 is a schematic state diagram of the vehicle door from FIG. 1;

FIG. 5 is a schematic state diagram of the vehicle door from FIG. 1 with comfort activation;

FIG. 6 is a schematic illustration of the relationship between the holding torques and the opening angle or a change in the opening angle; and

FIG. 7 is a schematic state diagram of a vehicle door with logically combined comfort functions according to an embodiment of the invention.

### DETAILED DESCRIPTION OF THE DRAWINGS

As is seen from FIG. 1, an exemplary vehicle door 2 according to the invention includes a sensor system 6 for sensing the movement of the door, an evaluation and control unit 7 for evaluating the sensed door movement and for actuating a damper 5 by using an actuator 4, the damper influencing the movement of the vehicle door 2 by using a set torque M. The evaluation and control unit 7 outputs, for example, a control voltage U which is converted into a current I by the actuator 4. In addition to the sensing of the door movement, the sensor system 6 can also include sensors for monitoring an internal or external door handle or for detecting obstacles in the opening region of the vehicle door 2.

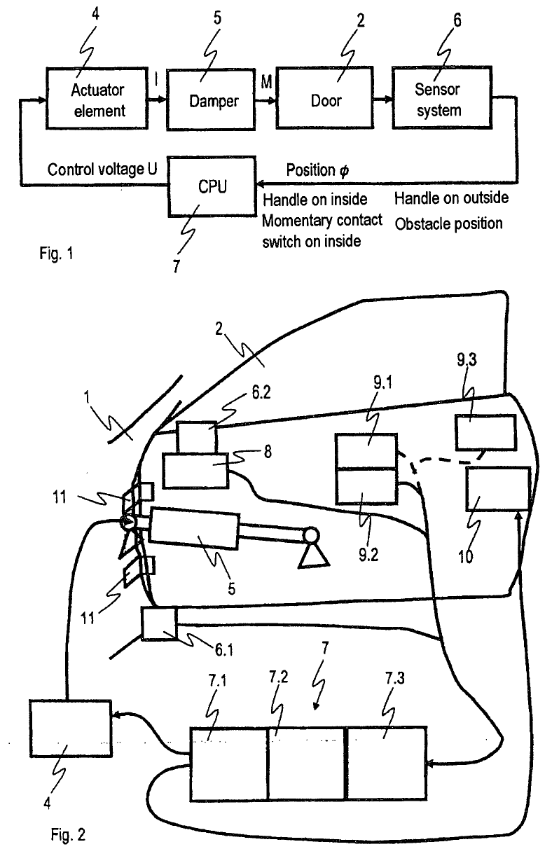

FIG. 2 shows a more detailed block diagram of the exemplary vehicle door 2 with a variable latching function for a vehicle 1. As is apparent from FIG. 2, the vehicle door 2 has hinges 11, the damper 5 with the actuator 4 which is embodied as a current controller and which is actuated by the evaluation and control unit 7, an internal handle 9.1, an external handle 9.3, a momentary contact switch 9.2, and a unit 10 for releasing the door lock, which unit 10 is activated by the momentary contact switch 9.2, arranged in the surroundings of the internal handle 9.1, via the evaluation and control unit 7. In order to evaluate the sensor signals and to output control signals, the evaluation and control unit 7 has a CPU 7.2 and an analogue/digital converter 7.3 which prepares the received sensor signals for processing in the CPU 7.2, and a digital/analog converter 7.1 which accordingly prepares the control signals from the CPU for outputting. For the purpose of receiving and for outputting, the evaluation and control unit additionally has digital inputs and outputs.

As is also apparent from FIG. 2, the exemplary sensor system 6 includes a position sensor 6.1 which detects the opening angle Θ of the vehicle door and transmits a corresponding signal to the evaluation and control unit 7, and a digital laser scanner 6.2 with associated control unit 8 for detecting obstacles. Optionally, further sensors can be arranged on the internal or external handle 9.1, 9.3 of the vehicle door 2 and connected to the evaluation and control unit 7 which detect activation of the associated handle 9.1, 9.3 and communicate it to the evaluation and control unit 7.

The illustrated hinges 11 of the vehicle door 2 do not have any fixed latching elements but rather permit low-force movement of the vehicle door independently of position. The hinges 11 are embodied in such a way that in a first segment 400 of the opening region of the vehicle door 2 from a minimum opening angle Θ₀ to a first opening angle Θₘᵢₙ, which is, for example, approximately 15°, the associated vehicle door 2 engages in the lock without the effect of external forces, that is to say is accelerated to relatively small positions in the direction of the minimum opening angle Θ₀.

In the enabled state the exemplary damper 5 has low friction and its holding force corresponds to a holding/braking torque of approximately 100 Nm. The damper 5 is embodied in such a way that it can be applied satisfactorily and quickly responds to the control signals.

In order to implement the variable latching function, various designs and principles of action can be selected for the damper 5. In principle, the dampers 5 are divided into rotary action and translatory action dampers. The possible actuators 4 for actuating the dampers 5 can be classified as electrohydraulic, electromechanical, magnetorheological and electrorheological principles of action. It is also possible to use active actuator units such as electric motors which act in a rotational or linear fashion and hydraulic drives.

For the variable latching function, the position of the vehicle door 2 is evaluated, the position being sensed, for example, as an opening angle Θ by the position sensor 6.1. The angular speed can be estimated by suitable filtering and differentiation of the signal of the position sensor 6.1. The low pass filtering which is used constitutes here a compromise between a signal which is as “smooth” as possible and which has minimized noise, and a system movement which is sufficiently unfalsified and has small delays. Angular sensors which operate according to the Hall principle or are embodied as rotary potentiometers can be used as position sensor 6.1. Furthermore, linear action longitudinal measuring systems with which the position of the vehicle door 2 can be determined can also be used. In one particularly advantageous embodiment of the vehicle door 2, it is not the displacement of the damper 5 which is sensed but rather the position of the vehicle door 2 itself, including the movements which occur owing to the elasticities in the mechanism of the vehicle door 2 and of the damper 5. If the position sensor 6.1 is integrated into the damper 5, elastic resilience is explicitly provided in the structure of the damper 5, the resilience permitting the sensor 6.1 to be able to sense a movement of the vehicle door 2 within the scope of its resilience even when the damper 5 is blocked.

In one exemplary embodiment, the variable latching function includes a comfort activation in which an activation request is sensed by a mechanical momentary contact switch which is let into the external handle 9.3 of the vehicle door 2, also used to detected whether the operator grasps the handle 9.3. Alternatively, a capacitive sensor on the internal handle 9.1 of the vehicle door 2 may be used. In addition to these sensors, which detect the driver's hand on the handle 9.1, 9.3, it is possible to arrange a further momentary contact switch at the upper end of the internal handle. Other sensors can also be used to sense the activation request. By using the sensors it is detected whether the driver grasps the internal or external door handle 9.1, 9.3. If this is the case, the latching force is switched off so that the driver can move the vehicle door 2 out of its latched position without applying force.

If the driver moves the vehicle door 2 and has his hand on one of the handles 9.1, 9.3 and if the driver lets go of the corresponding handle 9.1, 9.3, the vehicle door 2 is visibly braked and held in a latched position. As a result, the driver receives feedback as to whether and when the vehicle door 2 assumes the latched position.

The sensor 6.2 for detecting obstacles detects the position of objects in the opening region of the vehicle door 2, either in relation to the vehicle 1 or in relation to the current position of the vehicle door 2. In the illustrated exemplary embodiment, the obstacle sensor 6.2 is embodied as a laser scanner with an oscillating deflecting mirror. The laser scanner 6.2 is arranged on the vehicle door 2 in such a way that a plane which runs through the axis of the hinge but is at a corresponding angle to the surface of the vehicle door 2 is scanned. As a result, obstacles which approach the vehicle door 2 can be detected in good time. In such an arrangement of the obstacle sensor 6.2, no information is required about the precise position of the obstacle in space since the distance from the vehicle door 2 can be determined in a uniquely defined way in the relevant angular coordinates.

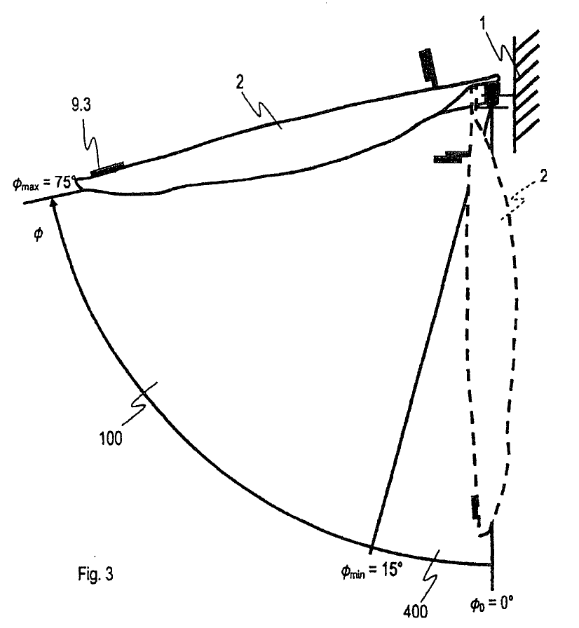

FIG. 3 shows the functional region 100 of the variable latching function. As is apparent from FIG. 3, the functional region 100 of the variable latching function extends, in the illustrated exemplary embodiment, from the first opening angle Θₘᵢₙ=15° up to the maximum opening angle Θₘₐₓ=75°. If the vehicle door 2 is brought to a standstill in any desired position within the functional region 100 of the variable latching elements, the vehicle door 2 is held at precisely this position by the holding moment of the damper 5. If the obstacle sensor 6.2 detects an obstacle within the opening region, the possible opening angle is limited in such a way that damage to the vehicle door 2 is prevented during the opening process. As a result, the functional region of the variable latching function is also reduced to the region which is less than the opening angle and which is predefined by the detected obstacle.

As is also apparent from FIG. 3, the functional region 100 of the variable latching function does not extend over the entire opening region of the vehicle door 2. In the first segment 400 of the opening region of the vehicle door 2 up to the first opening angle Θₘᵢₙ=15°, the vehicle door 2 is not latched. Since it is not possible to get into or out of the vehicle with such a small opening angle, this does not have an adverse influence on comfort. As a result of the configuration of the hinges 11 described above, the vehicle door 2 engages in the lock if it is positioned within the first segment 400 of the opening region. This functionality is ensured further by the limiting of the functional region 100 of the variable latching function. The vehicle door 2 is represented with the maximum possible opening angle Θₘₐₓ=75°. A vehicle door 2 which is illustrated by dashed lines shows the initial position of the vehicle door 2 with the minimum opening angle Θ₀=0°, i.e. the closed vehicle door 2.

In one embodiment of the variable latching function without comfort activation, the vehicle door 2 is held in a latched position if the vehicle door 2 is brought to a standstill within the functional region 100, or if the speed of the vehicle door 2 drops below a threshold value.

The latching torque is applied in a timed fashion, for example corresponding to a jump response of a PT₂ element in order to prevent jolting and thus to make the engagement of the vehicle door 2 haptically pleasant for the user. The latching torque holds the vehicle door 2 in its latched position. System-inherent rigidities in the vehicle door 2, the damper 5 and its attachments require a force-proportional deflection of the door about the latched position, i.e. any detected deflection about the latched position can be assigned an activation force in a uniquely defined fashion.

This property can be used to detect the request of the operator to switch off the latching elements. If a threshold value for the deflection out of the latched position is exceeded or if a known torque is exceeded, the latching torque is eliminated in a controlled fashion.

Alternatively, in order to switch off the latching torque, it is also possible to use a force/pressure sensor which is integrated, for example, in the connecting path between the damper 5 and support points of the damper 5.

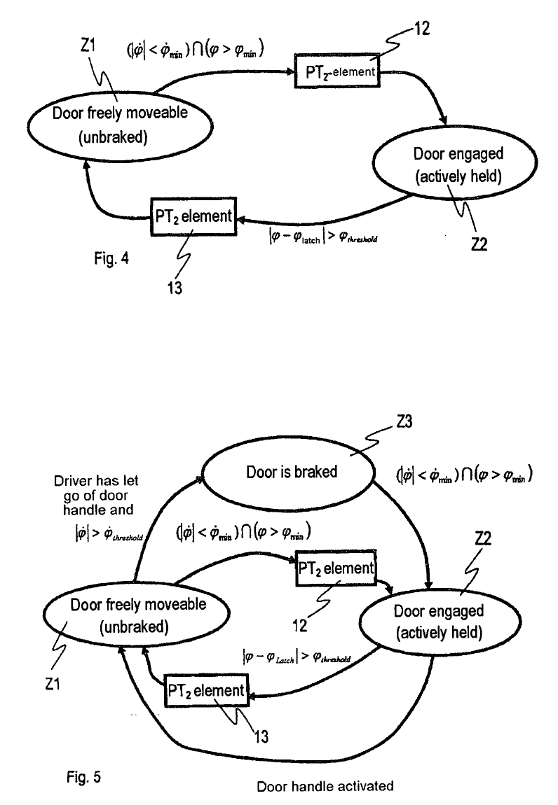

FIG. 4 shows a schematic state diagram of the vehicle door 2 with variable latching function without comfort activation. As is apparent from FIG. 4, the vehicle door 2 is freely moveable in a first state Z1 and if the current opening angle lies within the functional region 100 and the speed falls below a threshold value, it is braked by using a PT₂ element 12 with a first time constant. In a second state Z2, the vehicle door 2 is actively held in the instantaneous position by the latching torque until the deflection of the vehicle door 2 exceeds a predefined threshold value, with the latching torque being released by using a second PT₂ element 13 with a second time constant and the vehicle door 2 returning to the first state Z1. The PT₂ filters 12, 13 ensure jolt-free application and elimination of the latching torque and bring about a delay in the switching on and off of these signals and thus perceptibly increase the overall comfort of the system.

FIG. 5 shows a schematic state diagram of the vehicle door 2 with a variable latching function and comfort activation. As is apparent from FIG. 5, at the transition from the first state Z1 into the second state Z2 the vehicle door 2 can be actively braked by a braking function in a third state Z3, if a current speed of the vehicle door 2 exceeds a predefined threshold value, and the driver lets go of the door handle 9.1, 9.3. An additional transition from the second state Z2 into the first state Z1 takes place if one of the door handles 9.1, 9.3 is activated.

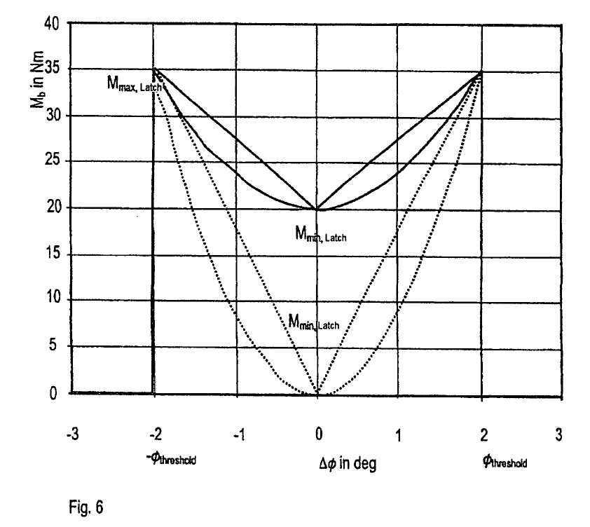

After the engagement in a desired latched position, the necessary setting of a braking torque or of the latching torque for holding the vehicle door 2 takes place. In the case of an actuator which does not require any energy to hold the door, it is possible for the maximum latching torque to be set here. In order to avoid consuming energy unnecessarily for the holding process when dampers 5 with an inverse functional principle are used, the latching torque is determined as a function of the current deviation with respect to the latched position ΔΘ=Θ−Θ_{latch}. Generally, given a predefined minimum or maximum latching torque: M_{min,latch}≦M_{latch}≦M_{max, latch}. FIG. 6 shows possible relationships of the latching torque M_{b}=f (Θ−Θ_{latch})=f(ΔΘ). The adjustable width ΔΘ of the latched position is, as is apparent from FIG. 6, set to a threshold value Θ_{threshold} of ±2°. The preset minimum and maximum latching torques M_{min,latch} and M_{max, latch} arise, for example, from measurements of conventional door opening mechanisms.

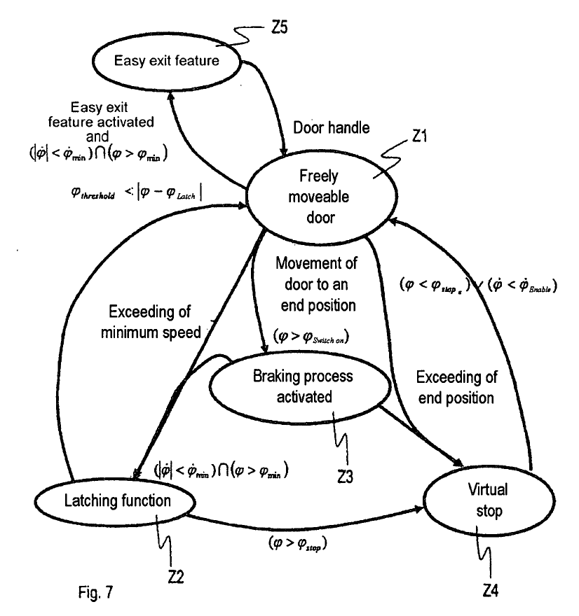

FIG. 7 shows a state diagram of the vehicle door 2 with a combination of a plurality of comfort functions. As is apparent from FIG. 7, in the first state Z1 the vehicle door 2 is freely moveable, and in a second state Z2 it is actively held in any desired latched position within the opening region of the vehicle door 2 by the variable latching function. If an obstacle is detected, the vehicle door 2 goes into a fourth state Z4 in the form of a virtual stop, which is assumed as a function of the distance of the vehicle door 2 from the detected obstacle. In the third state Z3, which has already been described, the vehicle door 2 can be braked actively by a braking function at the transition into the latched state Z2 or into the virtual stop Z4 or into one of the end positions of the opening region. As a result of the braking function in the state Z3, the vehicle door 2 reaches a predefined target position during the opening process with a speed of zero, and in the case of end position damping with a predefined target speed in the closing direction. The braking function in the state Z3 can additionally be activated in order to limit the door speed in the case of an opening or closing movement. The braking function is activated in this case if the door speed exceeds a predefined threshold value. A manual activation element 9.2 which is arranged in the surroundings of the internal handle 9.1 of the door can be used as a further comfort function for releasing a vehicle lock electronically before the vehicle door 2 is opened.

As is further apparent from FIG. 7, the vehicle door 2 has a fifth state Z5 which is activated by a predefined activation and acts as an easy exit feature, in which the vehicle door 2 is held with a maximum latching torque in a desired position until the easy exit feature is deactivated again.

The aforesaid comfort functions, which bring about transitions between the first to fourth states, are compatible with one another and can be combined with one another in any desired way, i.e. their activation and deactivation conditions are uniquely defined and can be combined without further measures.

Since the variable latching function and the easy exit feature have the same switching conditions for the activation of the holding force, these two functions cannot be implemented together in an unrestricted way. An exemplary implementation may include the variable latching function as a standard function, and the easy exit feature may, for example, be activated by activating a specific switch.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-11. (canceled)

12. A vehicle door with a variable latching function which holds the vehicle door in a desired latched position; comprising:
a controllable damper for applying a latching torque;
an evaluation and control unit for detecting a location of the desired latched position by evaluating an instantaneous door movement;
a sensor system for sensing the instantaneous door movement; and
an actuator element for activating the damper; wherein the evaluation and control unit releases the door from the latched position after a corresponding activation is detected;
and the variable latching function acts on the vehicle door within a functional region extending substantially to a predefined opening region between a first opening angle and a maximum opening angle when the vehicle door has a speed below a predefined speed within the functional region.

13. The vehicle door as claimed in claim 12, wherein, in a wider region substantially extending to a predefined opening region between a minimum opening angle and the first opening angle, the vehicle door moves into an initial position defined by the minimum opening angle when the vehicle door is positioned within the wider region.

14. The vehicle door as claimed in claim 12, wherein the latching torque for holding the desired latched position is applicable and releasable in a timed fashion.

15. The vehicle door as claimed in claim 14, wherein the latching torque is applicable and releasable by at least one PT₂ element having a predefined time constant.

16. The vehicle door as claimed in claim 12, wherein the latching torque for holding the vehicle door in the latched position which corresponds to a region about a central latched position is settable as a function of an identified, current deviation from the central latched position.

17. The vehicle door as claimed in claim 12, wherein the evaluation and control unit detects the desired latched position when a user lets go of one of an internal door handle, external door handle and a door frame in response to a detected movement of the vehicle door.

18. The vehicle door as claimed in claim 12, wherein the evaluation and control unit detects the activation for releasing the latched position when a user grasps one of an internal door handle, external door handle, and the door frame.

19. The vehicle door as claimed in claim 17, when a corresponding sensor system monitors one of the internal door handle, external door handle, and the door frame for activation by the user.

20. The vehicle door as claimed in claim 12, wherein the evaluation and control unit detects the activation for releasing the latched position when a force-proportional deflection of the vehicle door about the central latched position is detected, and wherein the force at least overcomes rigidities inherent to one of the vehicle door, the damper and the attachments.

21. The vehicle door as claimed in claim 20, wherein the evaluation and control unit releases the latched position when the deflection of the vehicle door from the latched position reaches or exceeds a predefined threshold value.

22. The vehicle door as claimed in claim 20, wherein one of a pressure sensor and force sensor detects the force, and wherein the evaluation and control unit releases the latched position when the detected force reaches or exceeds a predefined threshold value.

23. The vehicle door as claimed in claim 12, wherein the variable latching function acts on the vehicle door when it is stationary in the functional region.

24. The vehicle door as claimed in claim 18, when a corresponding sensor system monitors one of the internal door handle, external door handle, and the door frame for activation by the user.
